(19) United States
(12) Patent Application Publication
(10) Pub. No.: US 2021/0067984 A1
(43) Pub. Date: Mar. 4, 2021

(54) METHOD AND APPARATUS FOR PERFORMING MINIMIZATION OF DRIVE TEST

(71) Applicant: Beijing Xiaomi Mobile Software Co., Ltd., Beijing (CN)

(72) Inventor: Wei HONG, Beijing (CN)

(21) Appl. No.: 16/961,094

(22) PCT Filed: Jan. 22, 2018
(86) PCT No.: PCT/CN2018/073604

§ 371 Date: Jul. 9, 2020

(51) Int. Cl. H04W 24/02; H04W 24/08

(52) U.S. Cl. CPC H04W 24/02; H04W 4/80; H04W 24/08

(57) ABSTRACT

The present disclosure provides a method and apparatus for performing an MDT. The method is applied to a terminal and includes: detecting entering a coverage hole of a base station; obtaining measurement information of MDT for the coverage hole by performing an MDT on the coverage hole; and in response to that entering a coverage area of the base station is detected, sending the measurement information of MDT for the coverage hole to the base station, such that the base station determines a network condition of the coverage hole based on the measurement information of MDT for the coverage hole. Thus, the present disclosure can apply the MDT on the coverage hole, thereby expanding the application range of the MDT and also improving the practicality of the MDT.

### TECHNICAL FIELD

The present disclosure relates to the field of communication technologies, and in particular to a method and apparatus for performing a minimization of drive test.

### BACKGROUND

Drive tests can reflect a state of a network, provide direct measurement and evaluation on a network performance indicator, and identify a problem of the network. In the related art, traditional network optimization is based on data of the drive tests, which is network data such as voltage level and quality collected by a drive test instrument. Such data is analyzed to find the problem of the network, and then optimize the network for a problem area. However, the traditional network optimization often requires a lot of manpower, material resources, and capital investment, and also has very high experience requirements for network optimization personnel.

### SUMMARY

In order to overcome the problems in the related art, the examples of the present disclosure provide a method of performing an MDT and an apparatus for performing an MDT.

According to a first aspect of examples of the present disclosure, a method of performing an MDT is provided. The method is applied to a terminal, and the method includes:

detecting entering a coverage hole of a base station;

obtaining measurement information of MDT for the coverage hole by performing an MDT on the coverage hole; and

in response to that entering a coverage area of the base station is detected, sending the measurement information of MDT for the coverage hole to the base station, such that the base station determines a network condition of the coverage hole based on the measurement information of MDT for the coverage hole.

In an example, detecting entering the coverage hole of the base station includes:

detecting that a state of the terminal is switched from a first state to a second state, where the first state represents a state in which the MDT is able to be performed on the coverage area, and the second state represents a state in which the MDT is able to be performed on the coverage hole; and

determining that the terminal enters the coverage hole.

In an example, obtaining the measurement information of MDT for the coverage hole by performing the MDT on the coverage hole includes:

performing the MDT on a designated network device in the coverage hole, the obtained measurement information of MDT for the coverage hole including measurement information of MDT for the designated network device.

In an example, the designated network device includes a Bluetooth device and/or a wireless local area network device; and

the measurement information of MDT for the designated network device includes at least one of location information, signal strength, or measurement time of the Bluetooth device and/or the wireless local area network device.

In an example, the measurement information of MDT for the designated network device further includes a device identifier of the Bluetooth device and/or a device identifier of the wireless local area network device.

In an example, detecting entering the coverage area of the base station includes:

detecting that a state of the terminal is switched from a second state to a first state, where the first state represents a state in which the MDT is able to be performed on the coverage area, and the second state represents a state in which the MDT is able to be performed on the coverage hole; and

determining that the terminal enters the coverage area.

In an example, the first state refers to a camped normally state, and the second state refers to an any cell selection state or a camped on any cell state.

In an example, sending the measurement information of MDT for the coverage hole to the base station includes:

establishing a connection with the base station; and

sending the measurement information of MDT for the coverage hole to the base station.

According to a second aspect of the examples of the present disclosure, a method of performing an MDT is provided. The method is applied to a base station, and the method includes:

receiving measurement information of MDT for a coverage hole from a terminal, where the measurement information of MDT for the coverage hole is information obtained by performing an MDT on the coverage hole after the terminal detects entering the coverage hole of the base station; and

determining a network condition of the coverage hole based on the measurement information of MDT for the coverage hole.

In an example, the measurement information of MDT for the coverage hole includes measurement information of MDT for a designated network device in the coverage hole;

the designated network device includes a Bluetooth device and/or a wireless local area network device; and

the measurement information of MDT for the designated network device includes at least one of location information, signal strength, or measurement time of the Bluetooth device and/or the wireless local area network device.

According to a third aspect of the examples of the present disclosure, an apparatus for performing an MDT is provided. The apparatus is applied to a terminal, and the apparatus includes:

a first detection module configured to detect entering a coverage hole of a base station;

a measurement module configured to obtain measurement information of MDT for the coverage hole by performing an MDT on the coverage hole; and

a transmission module configured to, in response to that entering a coverage area of the base station is detected, send the measurement information of MDT for the coverage hole to the base station, such that the base station determines a network condition of the coverage hole based on the measurement information of MDT for the coverage hole.

In an example, the first detection module includes:

a detection sub-module configured to detect that a state of the terminal is switched from a first state to a second state, where the first state represents a state in which the MDT is able to be performed on the coverage area, and the second state represents a state in which the MDT is able to be performed on the coverage hole; and

a determination sub-module configured to determine that the terminal enters the coverage hole.

In an example, the measurement module includes:

a measurement sub-module configured to perform the MDT on a designated network device in the coverage hole, the obtained measurement information of MDT for the coverage hole including measurement information of MDT for the designated network device.

In an example, the designated network device includes a Bluetooth device and/or a wireless local area network device; and

the measurement information of MDT for the designated network device includes at least one of location information, signal strength, or measurement time of the Bluetooth device and/or the wireless local area network device.

In an example, the measurement information of MDT for the designated network device further includes a device identifier of the Bluetooth device and/or a device identifier of the wireless local area network device.

In an example, the apparatus further includes:

a second detection module configured to detect that a state of the terminal is switched from a second state to a first state, where the first state represents a state in which the MDT is able to be performed on the coverage area, and the second state represents a state in which the MDT is able to be performed on the coverage hole; and

a coverage determination module configured to determine that the terminal enters the coverage area.

In an example, the first state refers to a camped normally state, and the second state refers to an any cell selection state or a camped on any cell state.

In an example, the transmission module includes:

a connection sub-module configured to, in response to that entering the coverage area of the base station is detected, establish a connection with the base station; and

a transmission sub-module configured to send the measurement information of MDT for the coverage hole to the base station, such that the base station determines the network condition of the coverage hole based on the measurement information of MDT for the coverage hole.

According to a fourth aspect of the examples of the present disclosure, an apparatus for performing an MDT is provided. The apparatus being applied to a base station, and the apparatus includes:

a reception module configured to receive measurement information of MDT for a coverage hole from a terminal, where the measurement information of MDT for the coverage hole is information obtained by performing an MDT on the coverage hole after the terminal detects entering the coverage hole of the base station; and

a network-condition determination module configured to determine a network condition of the coverage hole based on the measurement information of MDT for the coverage hole.

In an example, the measurement information of MDT for the coverage hole includes measurement information of MDT for a designated network device in the coverage hole;

the designated network device includes a Bluetooth device and/or a wireless local area network device; and

the measurement information of MDT for the designated network device includes at least one of location information, signal strength, or measurement time of the Bluetooth device and/or the wireless local area network device.

According to a fifth aspect of the examples of the present disclosure, a non-transitory computer-readable storage medium is provided, having a computer program stored on the storage medium, where the computer program is configured to execute the method of performing an MDT according to the first aspect.

According to a sixth aspect of the examples of the present disclosure, a non-transitory computer-readable storage medium is provided, having a computer program stored on the storage medium, where the computer program is configured to execute the method of performing an MDT according to the second aspect.

According to a seventh aspect of the examples of the present disclosure, an apparatus for performing an MDT is provided. The apparatus is applied to a terminal, and the apparatus includes:

a processor; and

a memory for storing instructions executable by the processor,

where the processor is configured to:

detect entering a coverage hole of a base station;

obtain measurement information of MDT for the coverage hole by performing an MDT on the coverage hole; and

in response to that entering a coverage area of the base station is detected, send the measurement information of MDT for the coverage hole to the base station, such that the base station determines a network condition of the coverage hole based on the measurement information of MDT for the coverage hole.

According to an eighth aspect of the examples of the present disclosure, an apparatus for performing an MDT is provided. The apparatus is applied to a terminal, and the apparatus includes:

a processor; and

a memory for storing instructions executable by the processor,

where the processor is configured to:

receive measurement information of MDT for a coverage hole from a terminal, where the measurement information of MDT for the coverage hole is information obtained by performing an MDT on the coverage hole after the terminal detects entering the coverage hole of the base station; and

determine a network condition of the coverage hole based on the measurement information of MDT for the coverage hole.

The technical solutions provided by the examples of the present disclosure may include the following beneficial effects.

In the present disclosure, upon detecting entry into the coverage hole of the base station, the measurement information of MDT for the coverage hole of the base station can be obtained by performing the MDT on the coverage hole of the base station. When entry into the coverage area of the base station is detected, the measurement information of MDT for the coverage hole of the base station is sent to the base station, such that the base station determines the network condition of the coverage hole based on the measurement information of MDT for the coverage hole. In this way, after the terminal obtains the measurement information of MDT for the coverage hole in the coverage hole, the terminal will send the measurement information of MDT for the coverage hole to the base station instantly, such that the base station can quickly learn about the network condition of the coverage hole. Thus, the MDT is performed on the coverage hole, thereby expanding the application range of the MDT, and improving the practicality of the MDT.

In the present disclosure, after receiving the measurement information of MDT for the coverage hole sent by the terminal, the network condition of the coverage hole can be determined based on the measurement information of MDT for the coverage hole, thereby achieving network optimization for the coverage hole, and improving the practicality of the MDT.

It is to be understood that the above general descriptions and the below detailed descriptions are merely exemplary and explanatory, and are not intended to limit the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 is a flowchart illustrating a method of performing an MDT according to an example.

FIG. 2 is a schematic diagram illustrating an application scenario of a method of performing an MDT according to an example.

FIG. 3 is a flowchart illustrating another method of performing an MDT according to an example.

FIG. 4 is a flowchart illustrating another method of performing an MDT according to an example.

FIG. 5 is a flowchart illustrating another method of performing an MDT according to an example.

FIG. 6 is a flowchart illustrating another method of performing an MDT according to an example.

FIG. 7 is a flowchart illustrating a method of performing an MDT according to an example.

FIG. 8 is a block diagram illustrating an apparatus for performing an MDT according to an example.

FIG. 9 is a block diagram illustrating another apparatus for performing an MDT according to an example.

FIG. 10 is a block diagram illustrating another apparatus for performing an MDT according to an example.

FIG. 11 is a block diagram illustrating another apparatus for performing an MDT according to an example.

FIG. 12 is a block diagram illustrating another apparatus for performing an MDT according to an example.

FIG. 13 is a block diagram illustrating an apparatus for performing an MDT according to an example.

FIG. 14 is a schematic structural diagram illustrating an apparatus for performing an MDT according to an example.

FIG. 15 is a schematic structural diagram illustrating an apparatus for performing an MDT according to an example.

### DETAILED DESCRIPTION OF THE EMBODIMENTS

Examples will be described in detail herein, with the illustrations thereof represented in the drawings. When the following descriptions involve the drawings, like numerals in different drawings refer to like or similar elements unless otherwise indicated. The embodiments described in the following examples do not represent all embodiments consistent with the present disclosure. Rather, they are merely examples of apparatuses and methods consistent with some aspects of the present disclosure as detailed in the appended claims.

The terms used in the present disclosure are for the purpose of describing particular examples only, and are not intended to limit the present disclosure. Terms determined by “a”, “the” and “said” in their singular forms in the present disclosure and the appended claims are also intended to include plurality, unless clearly indicated otherwise in the context. It should also be understood that the term “and/or” as used herein is and includes any and all possible combinations of one or more of the associated listed items.

It is to be understood that, although terms “first,” “second,” “third,” and the like may be used in the present disclosure to describe various information, such information should not be limited to these terms. These terms are only used to distinguish one category of information from another. For example, without departing from the scope of the present disclosure, first information may be referred as second information; and similarly, second information may also be referred as first information. Depending on the context, the word “if” as used herein may be interpreted as “when” or “upon” or “in response to determining”

DTs (Drive Tests) can reflect a state of a network, provide direct measurement and evaluation on a network performance indicator, and identify a problem of the network. In the related art, traditional network optimization is based on data of the drive tests, which is network data such as voltage level and quality collected by a drive test instrument. Such data is analyzed to find the problem of the network, and then optimize the network for a problem area. However, the traditional network optimization often requires a lot of manpower, material resources, and capital investment, and also has very high experience requirements for network optimization personnel.

MDTs (Minimization of Drive Tests) technology mainly obtains relevant parameters required for network optimization through a measurement report which is reported by a mobile phone.

To make MDT more effective, at present, MDT application scenarios mainly include coverage optimization, capacity optimization, mobile optimization, QoS (Quality of Service) guarantee, etc.

At present, the MDT technology is mainly used in outdoor scenarios. In outdoor scenarios, a terminal can rely on GPS (Global Positioning System) for accurate positioning and information reporting. However, with the development of mobile communication technology, more and more mobile communications and traffic are generated indoors, and there are more and more Bluetooth devices and WLAN (Wireless Local Area Network) devices deployed indoors. The traditional MDT technology faces some challenges. For example, GPS positioning that the traditional MDT relies on cannot work normally indoors, resulting in inaccurate positioning. Therefore, how to apply MDT technology in indoor scenarios needs further research.

However, in the existing MDT mechanism, a terminal will perform MDT only when the terminal is in a “camped normally” state. If the terminal is in an “any cell selection” state or a “camped on any cell” state, the terminal will not perform MDT.

In view of the above problems, the present disclosure provides a method of performing an MDT. In this method, when detecting that a terminal enters a coverage hole of a base station, the terminal can perform MDT on the coverage hole of the base station to obtain measurement information of MDT for the coverage hole, and when detecting that the terminal enters the coverage area of the base station again, the terminal will send the measurement information of MDT for the coverage hole to the base station, such that the base station determines a network condition of the coverage hole based on the measurement information of MDT for the coverage hole, thereby achieving performing the MDT for the coverage hole and improving the practicality of the MDT.

The technical solutions provided by examples of the present disclosure will be described below with specific examples.

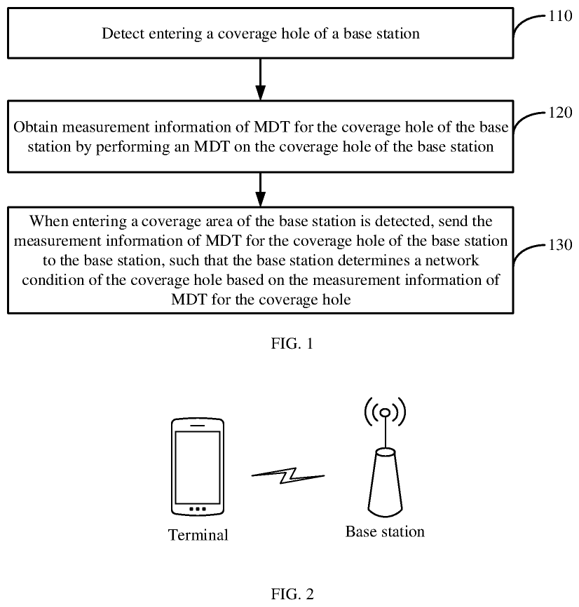

FIG. 1 is a flowchart illustrating a method of performing an MDT according to an example, and FIG. 2 is a schematic diagram illustrating an application scenario of a method of performing an MDT according to an example. The method of performing the MDT can be applied to a terminal. As shown in FIG. 1, the method of performing the MDT can include the following steps 110-130.

At step 110, entering a coverage hole of a base station is detected.

In the example of the present disclosure, the coverage hole of the base station can refer to an area where signal quality of a cellular network is lower than a threshold value and lasts for a certain period of time.

At step 120, measurement information of MDT for the coverage hole of the base station is obtained by performing an MDT on the coverage hole of the base station.

At step 130, when entering a coverage area of the base station is detected, the measurement information of MDT for the coverage hole of the base station is sent to the base station, such that the base station determines a network condition of the coverage hole based on the measurement information of MDT for the coverage hole.

In the example of the present disclosure, the coverage area of the base station can refer to an area where signal quality of a cellular network is higher than a threshold value and lasts for a certain period of time.

After the terminal obtains the measurement information of MDT for the coverage hole, when the terminal enters the coverage area of the base station again, the terminal will send the measurement information of MDT for the coverage hole to the base station instantly, such that the base station can quickly learn about the network condition of the coverage hole based on the measurement information of MDT for the coverage hole. For example, the measurement information of MDT includes location information of each network device included in the coverage hole, which facilitates the base station to accurately locate the coverage hole based on the location information of each network device included in the coverage hole, and to determine distribution of the network devices in the coverage hole. The base station can perform measurement and evaluation on the network performance indicators based on the measurement information of MDT, so as to identify a problem of the network. The network device included in the coverage hole can include a Bluetooth device and/or a WLAN device.

In an exemplary scenario, as shown in FIG. 2, the scenario includes a terminal and a base station. After the terminal detects that it enters a coverage hole of the base station, the terminal performs an MDT on the coverage hole of the base station to obtain measurement information of MDT for the coverage hole of the base station. When the terminal detects that it enters a coverage area of the base station, the terminal can send the measurement information of MDT to the base station, so that the base station determines the network condition of the coverage hole based on the measurement information of MDT for the coverage hole of the base station.

It can be seen from the above example that upon detecting entry into the coverage hole of the base station, the measurement information of MDT for the coverage hole of the base station can be obtained by performing the MDT on the coverage hole of the base station. When entry into the coverage area of the base station is detected, the measurement information of MDT for the coverage hole of the base station is sent to the base station, such that the base station determines the network condition of the coverage hole based on the measurement information of MDT for the coverage hole. In this way, after the terminal obtains the measurement information of MDT for the coverage hole in the coverage hole, the terminal will send the measurement information of MDT for the coverage hole to the base station instantly, such that the base station can quickly learn about the network condition of the coverage hole. Thus, the MDT is performed on the coverage hole, thereby expanding the application range of the MDT, and improving the practicality of the MDT.

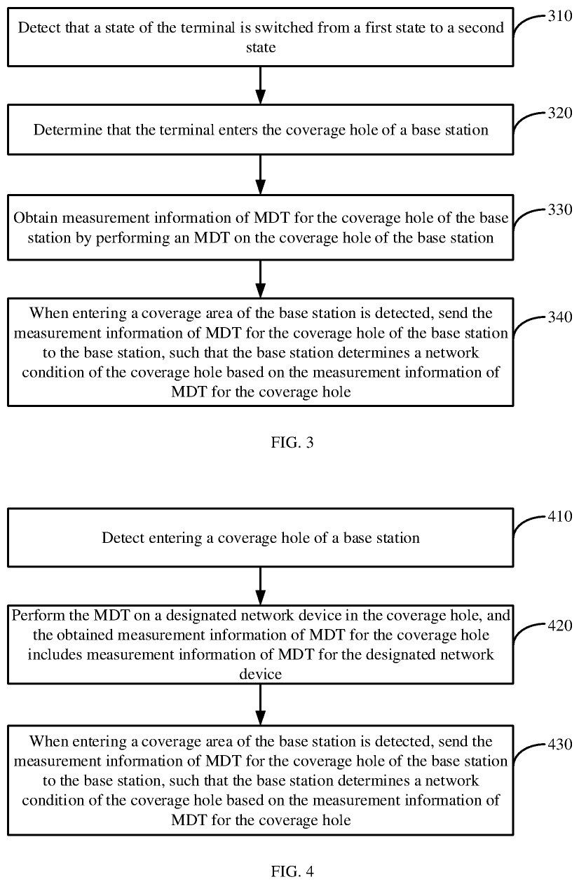

FIG. 3 is a flowchart illustrating another method of performing an MDT according to an example. The method of performing the MDT can be applied to a terminal and is on the basis of the method shown in FIG. 1. When step 110 is performed, whether the terminal enters the coverage hole of the base station can be determined based on a state change of the terminal. As shown in FIG. 3, the method of performing the MDT can include the following steps 310-340.

At step 310, it is detected that a state of the terminal is switched from a first state to a second state. The first state represents a state in which the MDT can be performed on a coverage area of a base station, and the second state represents a state in which the MDT can be performed on a coverage hole of the base station.

In an example, the first state can be a “camped normally” state, and the second state can be an “any cell selection” state, or a “camped on any cell” state.

When the terminal is in the camped normally state, the terminal can normally receive broadcast information sent by the base station, and can perform the MDT on the coverage area of the base station. For example, after a terminal is powered on, if the terminal can detect a cell fulfilled the S criterion, the terminal can enter the camped normally state.

When the state of the terminal is in the any cell selection state, or the camped on any cell state, the terminal cannot normally receive broadcast information sent by the base station, but the terminal can perform the MDT on the coverage hole of the base station. For example, after a terminal is powered on, if the terminal cannot find a suitable cell, the terminal will enter the any cell selection state, and if the terminal in any cell selection state finds an acceptable cell, the terminal will enter the camped normally state.

At step 320, it is determined that the terminal enters the coverage hole of the base station.

At step 330, measurement information of MDT for the coverage hole of the base station is obtained by performing an MDT on the coverage hole of the base station.

In the example of the present disclosure, the terminal performs the MDT on the coverage hole of the base station, and the purpose thereof is to collect network performance data of the coverage hole.

When performing the MDT on the coverage hole of the base station, the location of each network device, such as a Bluetooth device, and/or a WLAN device and the like, in the coverage hole can be measured. The obtained measurement information of MDT can include location information of each network device, which facilitates the base station to accurately locate the coverage hole based on the location information of each network device, and to determine the distribution of the network device in the coverage hole. The base station can measure and evaluate the network performance indicators based on the measurement information of MDT, so as to identify a problem of the network.

At step 340, when entering a coverage area of the base station is detected, the measurement information of MDT for the coverage hole of the base station is sent to the base station, such that the base station determines a network condition of the coverage hole based on the measurement information of MDT for the coverage hole. This step is the same as step 130 and will not be repeated here.

It can be seen from the above example that when detecting that the state of the terminal is switched from the first state to the second state, it can be determined that the terminal enters the coverage hole of the base station, and then the MDT is performed on the coverage hole of the base station to obtain measurement information of MDT for the coverage hole of the base station. When entering the coverage area of the base station is detected, the measurement information of MDT for the coverage hole of the base station is sent to the base station, so that the base station can determine the network condition of the coverage hole based on the measurement information of MDT for the coverage hole, thereby improving the accuracy in determining the coverage hole.

FIG. 4 is a flowchart illustrating another method of performing an MDT according to an example. The method of performing the MDT can be applied to a terminal and is on the basis of the method shown in FIG. 1. When step 120 is performed, the MDT can be performed on a designated network device in the coverage hole. As shown in FIG. 4, the method can include the following steps 410-430.

At step 410, entering a coverage hole of a base station is detected. This step is the same as step 110 and will not be repeated here.

At step 420, an MDT is performed on a designated network device in the coverage hole of the base station, and the obtained measurement information of MDT for the coverage hole of the base station includes measurement information of MDT for the designated network device.

In an example, the designated network device in the coverage hole of the base station can include a Bluetooth device, and/or a WLAN device, or the like.

In an example, the measurement information of MDT for the designated network device can include at least one of location information, signal strength, or measurement time of the Bluetooth device and/or the WLAN device.

In an example, the measurement information of MDT for the designated network device can include at least one of location information, signal strength, and measurement time of the Bluetooth device and/or the WLAN device, and can also include device identifiers of the Bluetooth device, and/or the WLAN device.

At step 430, when entering a coverage area of the base station is detected, the measurement information of MDT for the coverage hole of the base station is sent to the base station, such that the base station determines a network condition of the coverage hole based on the measurement information of MDT for the coverage hole. This step is the same as step 130 and will not be repeated here.

It can be seen from the above example that the MDT can be performed on the designated network device in the coverage hole of the base station, and the obtained measurement information of MDT for the coverage hole of the base station includes the measurement information of MDT for the designated network device. When entering the coverage area of the base station is detected, the measurement information of MDT for the coverage hole of the base station is sent to the base station, so that the base station can determine a network condition of each designated network device in the coverage hole based on the measurement information of MDT for the designated network device, thereby improving the accuracy of the MDT and the reliability of network optimization for the coverage hole.

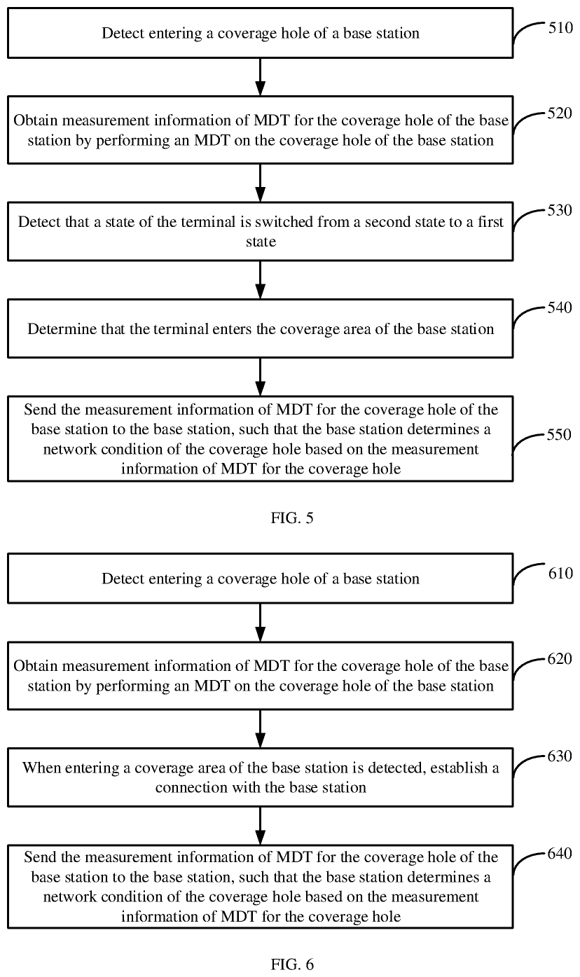

FIG. 5 is a flowchart illustrating another method of performing an MDT according to an example. The method of performing an MDT can be applied to a terminal and is on the basis of the method shown in FIG. 1. When step 130 is performed, whether the terminal enters the coverage area of the base station can be determined based on a state change of the terminal. As shown in FIG. 5, the method of performing the MDT can include the following steps 510-550.

At step 510, entering a coverage hole of a base station is detected. This step is the same as step 110 and will not be repeated here.

At step 520, measurement information of MDT for the coverage hole of the base station is obtained by performing an MDT on the coverage hole of the base station. This step is the same as step 120 and will not be repeated here.

At step 530, it is detected that a state of the terminal is switched from a second state to a first state. The first state represents a state in which the MDT can be performed on a coverage area of a base station, and the second state represents a state in which the MDT can be performed on a coverage hole of the base station.

In an example, the first state can be a camped normally state, and the second state can be an any cell selection state, or a camped on any cell state.

At step 540, it is determined that the terminal enters the coverage area of the base station.

At step 550, the measurement information of MDT for the coverage hole of the base station is sent to the base station, such that the base station determines a network condition of the coverage hole based on the measurement information of MDT for the coverage hole.

It can be seen from the above example that upon detecting that the terminal state is switched from the second state to the first state, it can be determined that the terminal enters the coverage area of the base station, which facilitates the terminal to instantly report the measured measurement information of MDT for the coverage hole to the base station, thereby improving the efficiency in transmission of the measurement information of MDT.

FIG. 6 is a flowchart illustrating another method of performing an MDT according to an example. The method of performing an MDT can be applied to a terminal and is on the basis of the method shown in FIG. 1. When step 130 is performed, a connection with the base station can be first established, and then the measurement information of MDT for the coverage hole of the base station is sent to the base station. As shown in FIG. 6, the method of performing the MDT can include the following steps 610-640.

At step 610, entering a coverage hole of a base station is detected. This step is the same as step 110 and will not be repeated here.

At step 620, measurement information of MDT for the coverage hole of the base station is obtained by performing an MDT on the coverage hole of the base station. This step is the same as step 120 and will not be repeated here.

At step 630, when entering a coverage area of the base station is detected, a connection is established with the base station.

At step 640, the measurement information of MDT for the coverage hole of the base station is sent to the base station, such that the base station determines a network condition of the coverage hole based on the measurement information of MDT for the coverage hole.

It can be seen from the above example that when detecting entry into the coverage area of the base station, a connection with the base station can be first established and then the measurement information of MDT for the coverage hole measured by the terminal is sent to the base station, thereby improving reliability in transmission of the measurement information of MDT.

FIG. 7 is a flowchart illustrating a method of performing an MDT according to an example. The method of performing the MDT can be applied to a base station. As shown in FIG. 7, the method of performing the MDT can include the following steps 710-720.

At step 710, measurement information of MDT for a coverage hole from a terminal is received, where the measurement information of MDT for the coverage hole is information obtained by performing an MDT on the coverage hole after the terminal detects entering the coverage hole of the base station.

In the example of the present disclosure, the coverage hole of the base station can refer to an area where signal quality of a cellular network is lower than a threshold value and lasts for a certain period of time.

In an example, the measurement information of MDT for the coverage hole includes measurement information of MDT for a designated network device in the coverage hole.

The designated network device includes a Bluetooth device and/or a WLAN device.

The measurement information of MDT for the designated network device includes at least one of location information, signal strength or measurement time of the Bluetooth device and/or the WLAN device.

At step 720, a network condition of the coverage hole is determined based on the measurement information of MDT for the coverage hole.

It can be seen from the above example that after receiving the measurement information of MDT for the coverage hole sent by the terminal, the network condition of the coverage hole can be determined based on the measurement information of MDT for the coverage hole, thereby achieving network optimization for the coverage hole, and improving the practicality of the MDT.

Corresponding to the above examples of the method of performing an MDT, the present disclosure also provides examples of the apparatus for performing an MDT.

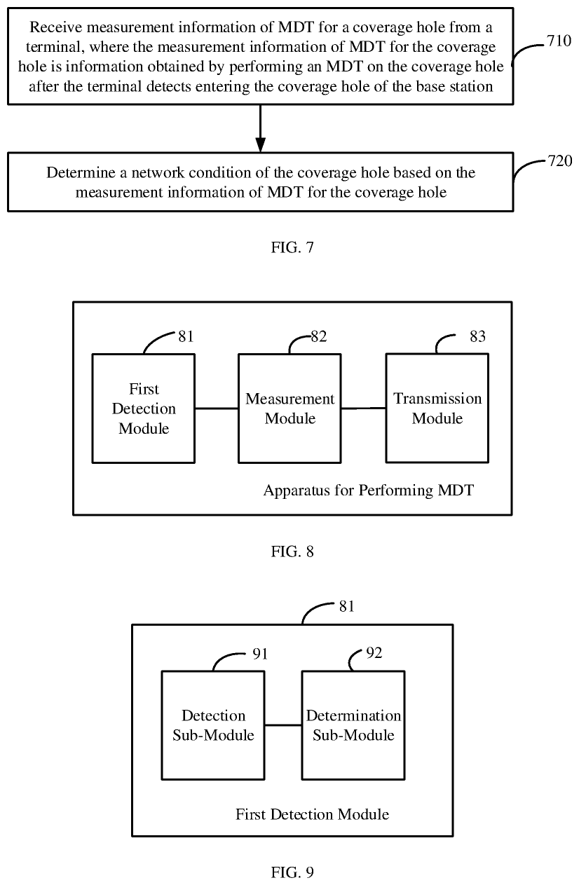

FIG. 8 is a block diagram illustrating an apparatus for performing an MDT according to an example. The apparatus is applied to a terminal, and is configured to perform the method of performing an MDT as shown in FIG. 1. As shown FIG. 8, the apparatus for performing the MDT can include:

a first detection module 81 configured to detect entering a coverage hole of a base station;

a measurement module 82 configured to obtain measurement information of MDT for the coverage hole by performing an MDT on the coverage hole; and

a transmission module 83 configured to, in response to that entering a coverage area of the base station is detected, send the measurement information of MDT for the coverage hole to the base station, such that the base station determines a network condition of the coverage hole based on the measurement information of MDT for the coverage hole.

It can be seen from the above example that after entering the coverage hole of the base station is detected, the MDT can be performed on the coverage hole of the base station to obtain the measurement information of MDT for the coverage hole of the base station. When entering the coverage area of the base station is detected, the measurement information of MDT for the coverage hole of the base station is sent to the base station, such that the base station determines the network condition of the coverage hole based on the measurement information of MDT for the coverage hole. In this way, after the terminal obtains the measurement information of MDT for the coverage hole in the coverage hole, the terminal will send the measurement information of MDT for the coverage hole to the base station instantly, such that the base station can quickly learn about the network condition of the coverage hole. Thus, the MDT is performed on the coverage hole, thereby expanding the application range of the MDT, and improving the practicality of the MDT.

In an example, based on the apparatus shown in FIG. 8, as shown FIG. 9, the first detection module 81 can include:

a detection sub-module 91 configured to detect that a state of the terminal is switched from a first state to a second state, where the first state represents a state in which the MDT is able to be performed on the coverage area, and the second state represents a state in which the MDT is able to be performed on the coverage hole; and

a determination sub-module 92 configured to determine that the terminal enters the coverage hole.

It can be seen from the above example that when detecting that the state of the terminal is switched from the first state to the second state, it can be determined that the terminal enters the coverage hole of the base station, and then the MDT is performed on the coverage hole of the base station to obtain measurement information of MDT for the coverage hole of the base station. When entering the coverage area of the base station is detected, the measurement information of MDT for the coverage hole of the base station is sent to the base station, so that the base station can determine the network condition of the coverage hole based on the measurement information of MDT for the coverage hole, thereby improving the accuracy in determining the coverage hole.

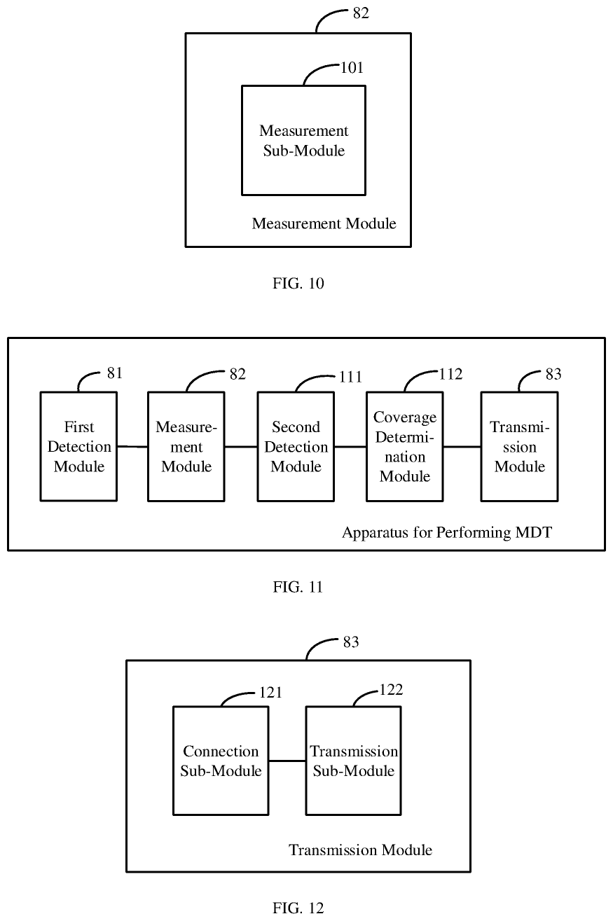

In an example, based on the apparatus shown in FIG. 8, as shown FIG. 10, the measurement module 82 can include:

a measurement sub-module 101 configured to perform the MDT on a designated network device in the coverage hole, and the obtained measurement information of MDT for the coverage hole includes measurement information of MDT for the designated network device.

It can be seen from the above example that the MDT can be performed on the designated network device in the coverage hole of the base station, and the obtained measurement information of MDT for the coverage hole of the base station includes the measurement information of MDT for the designated network device. When entering the coverage area of the base station is detected, the measurement information of MDT for the coverage hole of the base station is sent to the base station, so that the base station can determine a network condition of each designated network device in the coverage hole based on the measurement information of MDT for the designated network device, thereby improving the accuracy of the MDT and the reliability of network optimization for the coverage hole.

In an example, based on the apparatus shown in FIG. 10, the designated network device includes a Bluetooth device and/or a WLAN device.

The measurement information of MDT for the designated network device includes at least one of location information, signal strength, or measurement time of the Bluetooth device and/or the wireless local area network device.

In an example, the measurement information of MDT for the designated network device also includes a device identifier of the Bluetooth device and/or a device identifier of the wireless local area network device.

In an example, based on the apparatus shown in FIG. 8, as shown FIG. 11, the apparatus also includes:

a second detection module 111 configured to detect that a state of the terminal is switched from a second state to a first state, where the first state represents a state in which the MDT is able to be performed on the coverage area, and the second state represents a state in which the MDT is able to be performed on the coverage hole; and

a coverage determination module 112 configured to determine that the terminal enters the coverage area.

It can be seen from the above example that upon detecting that the terminal state is switched from the second state to the first state, it can be determined that the terminal enters the coverage area of the base station, which facilitates the terminal to instantly report the measured measurement information of MDT for the coverage hole to the base station, thereby improving the efficiency in transmission of the measurement information of MDT.

In an example, based on the apparatus shown in FIG. 9 or 11, the first state refers to a camped normally state, and the second state refers to an any cell selection state or a camped on any cell state.

In an example, based on the apparatus shown in FIG. 8, as shown FIG. 12, the transmission module 83 can include:

a connection sub-module 121 configured to, in response to that entering the coverage area of the base station is detected, establish a connection with the base station; and

a transmission sub-module 122 configured to send the measurement information of MDT for the coverage hole to the base station, such that the base station determines the network condition of the coverage hole based on the measurement information of MDT for the coverage hole.

It can be seen from the above example that when detecting entry into the coverage area of the base station, a connection with the base station can be first established and then the measurement information of MDT for the coverage hole measured by the terminal is sent to the base station, thereby improving reliability in transmission of the measurement information of MDT.

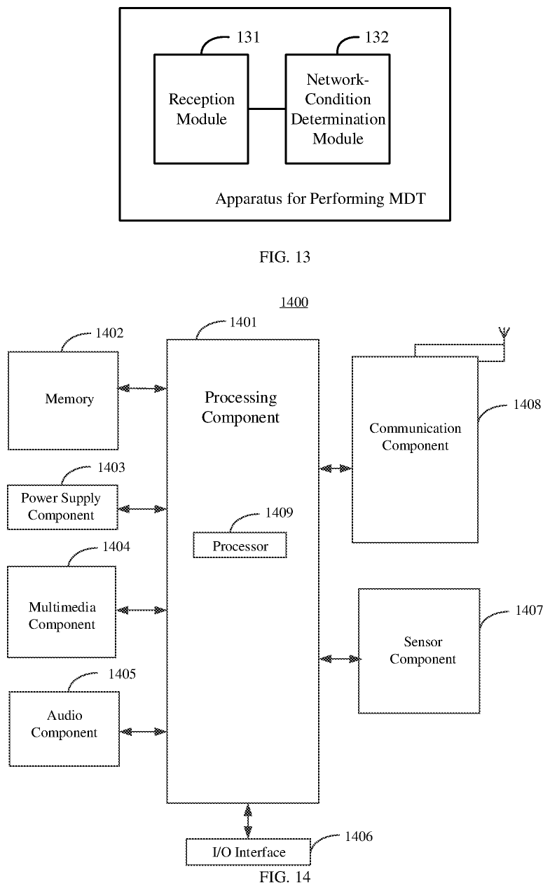

FIG. 13 is a block diagram illustrating an apparatus for performing an MDT according to an example. The apparatus is applied to a base station, and is configured to perform the method of performing an MDT as shown in FIG. 7. As shown FIG. 13, the apparatus for performing the MDT can include:

a reception module 131 configured to receive measurement information of MDT for a coverage hole from a terminal, where the measurement information of MDT for the coverage hole is information obtained by performing an MDT on the coverage hole after the terminal detects entering the coverage hole of the base station; and

a network-condition determination module 132 configured to determine a network condition of the coverage hole based on the measurement information of MDT for the coverage hole.

It can be seen from the above example that after receiving the measurement information of MDT for the coverage hole sent by the terminal, the network condition of the coverage hole can be determined based on the measurement information of MDT for the coverage hole, thereby achieving network optimization for the coverage hole, and improving the practicality of the MDT.

In an example, based on the apparatus as shown in FIG. 13, the measurement information of MDT for the coverage hole includes measurement information of MDT for a designated network device in the coverage hole.

The designated network device includes a Bluetooth device and/or a WLAN device.

The measurement information of MDT for the designated network device includes at least one of location information, signal strength, or measurement time of the Bluetooth device and/or the wireless local area network device.

Since the apparatus examples substantially correspond to the method examples, a reference may be made to part of the descriptions of the method examples for the related part. The apparatus examples described above are merely illustrative, where the units described as separate members may be or not be physically separated, and the members displayed as units may be or not be physical units, e.g., may be located in one place, or may be distributed to a plurality of network units. Part or all of the modules may be selected according to actual requirements to implement the objectives of the solutions in the examples. Those of ordinary skill in the art may understand and carry out them without creative work.

The present disclosure also provides a non-transitory computer-readable storage medium on which a computer program is stored, and the computer program is configured to execute any of the method of performing an MDT described above in FIGS. 1 to 6.

The present disclosure also provides a non-transitory computer-readable storage medium on which a computer program is stored, and the computer program is configured to execute the method of performing an MDT described above in FIG. 7.

The present disclosure also provides an apparatus for performing an MDT, which is applied to a terminal and includes:

a processor; and

a memory storing instructions executable by the processor;

where the processor is configured to:

detect entering a coverage hole of a base station;

obtain measurement information of MDT for the coverage hole by performing an MDT on the coverage hole; and

in response to that entering a coverage area of the base station is detected, send the measurement information of MDT for the coverage hole to the base station, such that the base station determines a network condition of the coverage hole based on the measurement information of MDT for the coverage hole.

FIG. 14 is a block diagram illustrating a structure of an apparatus for performing an MDT according to an example. As shown in FIG. 14, an apparatus 1400 for performing an MDT is illustrated according to an example, and the apparatus 1400 may be a terminal such as a computer, a mobile phone, a digital broadcasting terminal, a messaging device, a game console, a tablet device, a medical device, fitness equipment, a personal digital assistant, or the like.

As shown in FIG. 14, the apparatus 1400 may include one or more of the following components: a processing component 1401, a memory 1402, a power supply component 1403, a multimedia component 1404, an audio component 1405, an input/output (I/O) interface 1406, a sensor component 1407, and a communication component 1408.

The processing component 1401 generally controls overall operations of the apparatus 1400, such as operations associated with display, phone calls, data communications, camera operations, and recording operations. The processing component 1401 may include one or more processors 1409 to execute instructions to complete all or part of the steps of the above methods. In addition, the processing component 1401 may include one or more modules which facilitate the interaction between the processing component 1401 and other components. For example, the processing component 1401 may include a multimedia module to facilitate the interaction between the multimedia component 1404 and the processing component 1401.

The memory 1402 is to store various types of data to support the operation of the apparatus 1400. Examples of such data include instructions for any application or method operated on the apparatus 1400, contact data, phonebook data, messages, pictures, videos, and so on. The memory 1402 may be implemented by any type of volatile or non-volatile storage devices or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or compact disk.

The power supply component 1403 supplies power for different components of the apparatus 1400. The power supply component 1403 may include a power supply management system, one or more power supplies, and other components associated with generating, managing and distributing power for the apparatus 1400.

The multimedia component 1404 includes a screen providing an output interface between the apparatus 1400 and a user. In some examples, the screen may include a Liquid Crystal Display (LCD) and a Touch Panel (TP). If the screen includes the TP, the screen may be implemented as a touch screen to receive input signals from the user. The TP may include one or more touch sensors to sense touches, swipes, and gestures on the TP. The touch sensors may not only sense a boundary of a touch or swipe, but also sense a duration and a pressure associated with the touch or swipe. In some examples, the multimedia component 1404 may include a front camera and/or a rear camera. The front camera and/or rear camera may receive external multimedia data when the apparatus 1400 is in an operating mode, such as a photographing mode or a video mode. Each of the front camera and the rear camera may be a fixed optical lens system or have focal length and optical zooming capability.

The audio component 1405 is to output and/or input an audio signal. For example, the audio component 1405 includes a microphone (MIC). When the apparatus 1400 is in an operating mode, such as a call mode, a record mode and a voice recognition mode, the microphone is to receive an external audio signal. The received audio signal may be further stored in the memory 1402 or sent via the communication component 1408. In some examples, the audio component 1405 further includes a speaker for outputting an audio signal.

The I/O interface 1406 provides an interface between the processing component 1401 and a peripheral interface module. The above peripheral interface module may be a keyboard, a click wheel, buttons, or the like. These buttons may include but not limited to, a home button, a volume button, a start button and a lock button.

The sensor component 1407 includes one or more sensors to provide status assessments of various aspects for the apparatus 1400. For example, the sensor component 1407 may detect the on/off status of the apparatus 1400, and relative positioning of component, for example, the component is a display and a keypad of the apparatus 1400. The sensor component 1407 may also detect a change in position of the apparatus 1400 or a component of the apparatus 1400, a presence or absence of the contact between a user and the apparatus 1400, an orientation or an acceleration/deceleration of the apparatus 1400, and a change in temperature of the apparatus 1400. The sensor component 1407 may include a proximity sensor to detect the presence of a nearby object without any physical contact. The sensor component 1407 may further include an optical sensor, such as a Complementary Metal-Oxide-Semiconductor (CMOS) or Charged Coupled Device (CCD) image sensor which is used in imaging applications. In some examples, the sensor component 1407 may further include an acceleration sensor, a gyroscope sensor, a magnetic sensor, a pressure sensor, or a temperature sensor.

The communication component 1408 is to facilitate wired or wireless communication between the apparatus 1400 and other devices. The apparatus 1400 may access a wireless network based on a communication standard, such as Wi-Fi, 2G or 3G, or a combination thereof. In an example, the communication component 1408 receives a broadcast signal or broadcast related information from an external broadcast management system via a broadcast channel In an example, the communication component 1408 may further include a Near Field Communication (NFC) module for promoting short-range communication. For example, the NFC module may be implemented based on a radio frequency identification (RFID) technology, an infrared data association (IrDA) technology, an ultra-wideband (UWB) technology, a Bluetooth® (BT) technology and other technologies.

In an example, the apparatus 1400 may be implemented by one or more Application Specific Integrated Circuits (ASICs), Digital Signal Processors (DSPs), Digital Signal Processing Devices (DSPDs), programmable Logic Devices (PLDs), Field Programmable Gate Arrays (FPGAs), controllers, microcontrollers, microprocessors, or other electronic components for performing the above methods.

In an example, there is further provided a non-transitory computer readable storage medium including instructions, such as the memory 1402 including instructions. The above instructions may be executed by the processor 1409 of the apparatus 1400 to complete the above method. For example, the non-transitory computer readable storage medium may be a Read-Only Memory (ROM), a Random Access Memory (RAM), a CD-ROM, a magnetic tape, a floppy disk, an optical data storage device, and so on.

When instructions in the storage medium are executed by the processor, the device 1400 can execute any one of the methods of performing an MDT described above.

The present disclosure also provides an apparatus for performing an MDT, which is applied to a base station and includes:

a processor; and

a memory for storing processor executable instructions;

where the processor is configured to:

receive measurement information of MDT for a coverage hole from a terminal, where the measurement information of MDT for the coverage hole is information obtained by performing an MDT on the coverage hole after the terminal detects entering the coverage hole of the base station; and

determine a network condition of the coverage hole based on the measurement information of MDT for the coverage hole.

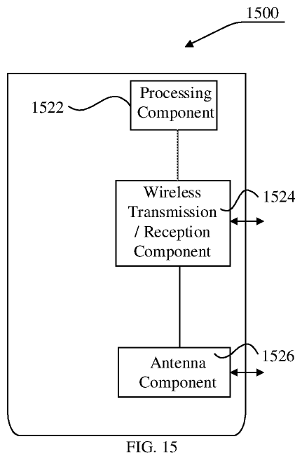

As shown in FIG. 15, FIG. 15 is a block diagram illustrating a structure of an apparatus for performing an MDT according to an example. The apparatus 1500 may be provided as a base station. Referring to FIG. 15, the apparatus 1500 includes a processing component 1522, a wireless transmission/reception component 1524, an antenna component 1526, and a signal processing part unique to a wireless interface. The processing component 1522 may further include one or more processors.

One of the processors in the processing component 1522 may be configured to perform any of the method of performing an MDTs described above.

Other implementations of the present disclosure will be apparent to those skilled in the art from consideration of the specification and practice of the present disclosure herein. The present disclosure is intended to cover any variations, uses, modification or adaptations of the present disclosure that follow the general principles thereof and include common knowledge or conventional technical means in the related art that are not disclosed in the present disclosure. The specification and examples are considered as exemplary only, with a true scope and spirit of the present disclosure being indicated by the following claims.

It is to be understood that the present disclosure is not limited to the precise structure described above and shown in the accompanying drawings, and that various modifications and changes may be made without departing from the scope thereof. The scope of the present disclosure is limited only by the appended claims.

1. A method of performing a Minimization of Drive Test (MDT), applied to a terminal, and comprising:
detecting entering a coverage hole of a base station;
obtaining measurement information of MDT for the coverage hole by performing an MDT on the coverage hole; and
in response to that entering a coverage area of the base station is detected, sending the measurement information of MDT for the coverage hole to the base station, such that the base station determines a network condition of the coverage hole based on the measurement information of MDT for the coverage hole.

2. The method according to claim 1, wherein detecting entering the coverage hole of the base station comprises:
detecting that a state of the terminal is switched from a first state to a second state, wherein the first state represents a state in which the MDT is able to be performed on the coverage area, and the second state represents a state in which the MDT is able to be performed on the coverage hole; and
determining that the terminal enters the coverage hole.

3. The method according to claim 1, wherein obtaining the measurement information of MDT for the coverage hole by performing the MDT on the coverage hole comprises:
performing the MDT on a designated network device in the coverage hole, the obtained measurement information of MDT for the coverage hole comprising measurement information of MDT for the designated network device.

4. The method according to claim 3, wherein the designated network device comprises at least one of a Bluetooth device or a wireless local area network device; and
the measurement information of MDT for the designated network device comprises at least one of location information, signal strength, or measurement time of the at least one of the Bluetooth device or the wireless local area network device.

5. The method according to claim 4, wherein the measurement information of MDT for the designated network device further comprises at least one of a device identifier of the Bluetooth device or a device identifier of the wireless local area network device.

6. The method according to claim 1, wherein detecting entering the coverage area of the base station comprises:
detecting that a state of the terminal is switched from a second state to a first state, wherein the first state represents a state in which the MDT is able to be performed on the coverage area, and the second state represents a state in which the MDT is able to be performed on the coverage hole; and
determining that the terminal enters the coverage area.

7. The method according to claim 2, wherein the first state is a camped normally state, and the second state is an any cell selection state or a camped on any cell state.

8. The method according to claim 1, wherein sending the measurement information of MDT for the coverage hole to the base station comprises:
establishing a connection with the base station; and
sending the measurement information of MDT for the coverage hole to the base station.

9. A method of performing an MDT, applied to a base station, and comprising:
receiving measurement information of MDT for a coverage hole from a terminal, wherein the measurement information of MDT for the coverage hole is information obtained by performing an MDT on the coverage hole after the terminal detects entering the coverage hole of the base station; and
determining a network condition of the coverage hole based on the measurement information of MDT for the coverage hole.

10. The method according to claim 9, wherein the measurement information of MDT for the coverage hole comprises measurement information of MDT for a designated network device in the coverage hole;
the designated network device comprises at least one of a Bluetooth device or a wireless local area network device; and
the measurement information of MDT for the designated network device comprises at least one of location information, signal strength, or measurement time of the at least one of the Bluetooth device or the wireless local area network device.

11. A terminal, comprising:
a processor; and
a memory storing instructions executable by the processor;
wherein the processor is configured to:
detect entering a coverage hole of a base station;
obtain measurement information of MDT for the coverage hole by performing an MDT on the coverage hole; and
in response to that entering a coverage area of the base station is detected, send the measurement information of MDT for the coverage hole to the base station, such that the base station determines a network condition of the coverage hole based on the measurement information of MDT for the coverage hole.

12. The terminal according to claim 11, wherein the processor is further configured to:
detect that a state of the terminal is switched from a first state to a second state, wherein the first state represents a state in which the MDT is able to be performed on the coverage area, and the second state represents a state in which the MDT is able to be performed on the coverage hole; and
determine that the terminal enters the coverage hole.

13. The terminal according to claim 11, wherein the processor is further configured to:
perform the MDT on a designated network device in the coverage hole, the obtained measurement information of MDT for the coverage hole comprising measurement information of MDT for the designated network device.

14. The terminal according to claim 13, wherein the designated network device comprises at least one of a Bluetooth device or a wireless local area network device; and
the measurement information of MDT for the designated network device comprises at least one of location information, signal strength, or measurement time of the at least one of the Bluetooth device or the wireless local area network device.

15. The terminal according to claim 14, wherein the measurement information of MDT for the designated network device further comprises at least one of a device identifier of the Bluetooth device or a device identifier of the wireless local area network device.

16. The terminal according to claim 11, wherein the processor is further configured to:
detect that a state of the terminal is switched from a second state to a first state, wherein the first state represents a state in which the MDT is able to be performed on the coverage area, and the second state represents a state in which the MDT is able to be performed on the coverage hole; and
determine that the terminal enters the coverage area.

17. The terminal according to claim 12, wherein the first state is a camped normally state, and the second state is an any cell selection state or a camped on any cell state.

18. The terminal according to claim 11, wherein the processor is further configured to:
in response to that entering the coverage area of the base station is detected, establish a connection with the base station; and
send the measurement information of MDT for the coverage hole to the base station, such that the base station determines the network condition of the coverage hole based on the measurement information of MDT for the coverage hole.

19. A base station, comprising:
a processor; and
a memory storing instructions executable by the processor;
wherein the processor is configured to perform the method according to claim 9.

20. The base station according to claim 19, wherein the measurement information of MDT for the coverage hole comprises measurement information of MDT for a designated network device in the coverage hole;
the designated network device comprises at least one of a Bluetooth device or a wireless local area network device; and
the measurement information of MDT for the designated network device comprises at least one of location information, signal strength, or measurement time of the at least one of the Bluetooth device or the wireless local area network device.

21.-24. (canceled)
